(19) United States
(12) Patent Application Publication
(10) Pub. No.: US 2007/0221027 A1
(43) Pub. Date: Sep. 27, 2007

(54) Enhanced logdog

(76) Inventor: John Victor Kananen, Pound, WI (US)

Correspondence Address: John Victor Kananen, W11030 W.26 th. Rd., Pound, WI, 54161, US

(21) Appl. No.: 11/361,886

(22) Filed: Feb. 27, 2006

(51) Int. Cl. B26D 7/02; B25B 5/16

(52) U.S. Cl. 83/452; 269/257

(57) ABSTRACT

A enhanced logdog that provides a positive grip on all surfaces while allowing more clearance for the saw blade. The unit is designed to fit on exiting equipment and mating to that equipment in such a fashion as not to diminish the integrity of it.

### FIELD OF THE INVENTION

The present invention relates to portable sawmills and in particular large logs and cants of all sizes.

### BACKGROUND OF THE INVENTION

Most small portable sawmill operators are a one man operation. Which leaves him with many details to attend to. The most common mistake is not having clearance for the blade, subsequently pruning the saw blade into a portion of the mill. and ruining the blade(been there many times).

The operator must realize every last board foot from every log. To that end most “cants” will have round corners with bark on them. This presents a clamping problem with exiting mills.

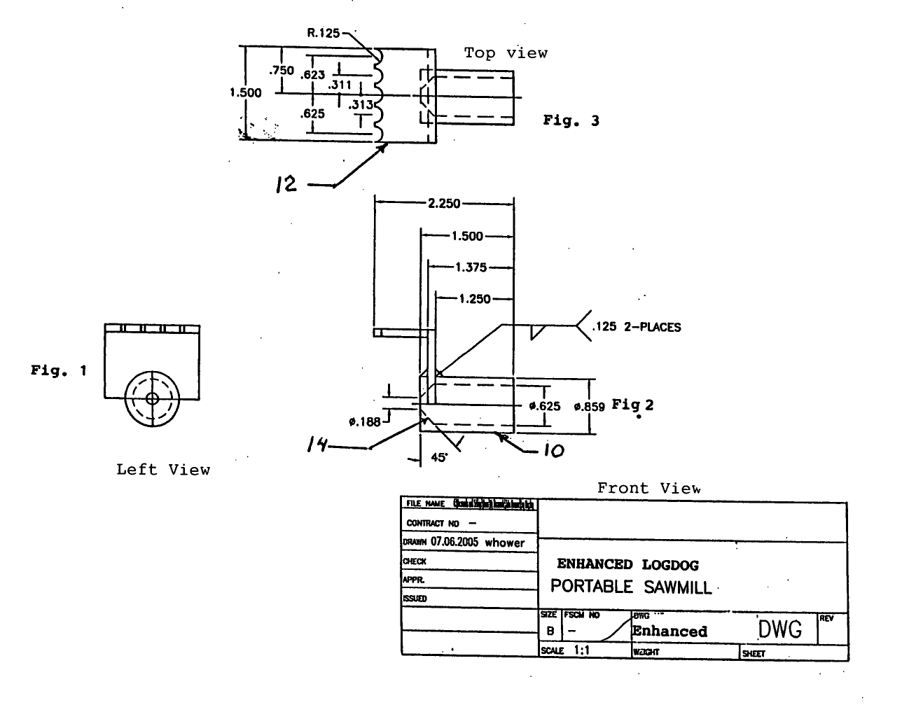

FIG. 1 show the ideal spot {center line of log} at A to clamp, but present equipment can't reach that high, or wouldn't clear the frame of the mill.

When using enhanced logdog you can clamp at B.

FIG. 2 shows the problem when there is a rounded corner.

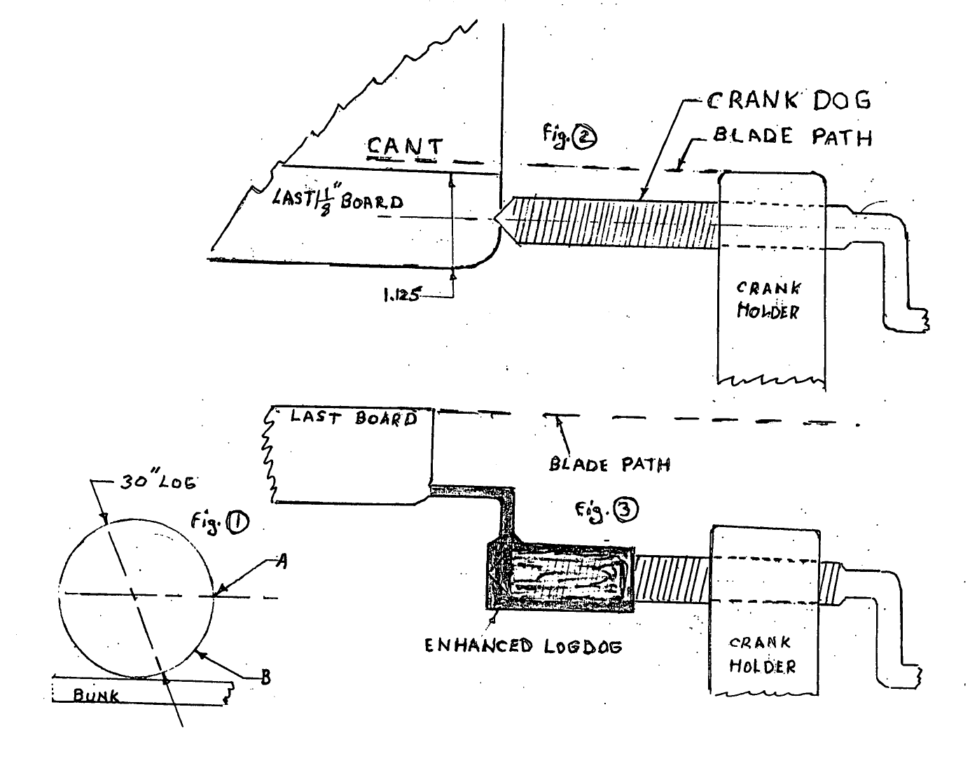

FIG. 3 shows the added clearance using enhanced logdog.

It is therefore an object of the invention to provide a positive tooth bar that can grip slippery surfaces as well rounded and bark covered.

It is another object of the invention to provide a barrel to fit over existing screw dog equipment.

It is another object of the invention to provide thrust block that mates with exiting equipment in a fashion that will not damage exiting dog.

It is another object of the invention to provide a enhanced logdog that gives added clearance for the saw blade while maintaining grip on rounded, slippery and bark covered surfaces.

### SUMMARY OF THE INVENTION

In accordance with the present invention, there is provided.

### BRIEF DESCRIPTION OF THE DRAWINGS

A complete understanding of the present invention may be obtained by reference to the accompanying drawings, when considered in conjunction with the subsequent, detailed description, in which:

For purposes of clarity and brevity, like elements and components will bear the same designations and numbering throughout the Figures.

### DESCRIPTION OF THE PREFERRED EMBODIMENT

The barrel 10 of the Enhanced logdog is made of steel pipe with a hole dia. to easily slide over the threaded dog. This hole can be larger or smaller to accommodate different makes of sawmills. The barrel 10 also can be made of solid steel and while machining the hole the thrust block 14 could be formed at the same time with a mating angle.

In accordance with the present invention, there is provided tooth bar 12 that gripes the log or cant. This could be made of steel angle iron like ⅛×1×1.

There is further provided a relief hole to protect the integrity of the end of the threaded screw dog.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An enhanced logdog for to provide a positive grip on a log or “cant” while giving clearance for the saw blade, comprising:
means for <purpose>;
means for <purpose>;
means for <purpose>; and
means for <purpose>.

2. The enhanced logdog in accordance with claim 1, wherein said means for <purpose> comprises a new attribute 1 barrel.

3. The enhanced logdog in accordance with claim 1, wherein said means for <purpose> comprises a new attribute 1 tooth bar.

4. The enhanced logdog in accordance with claim 1, wherein said means for <purpose> comprises a new attribute 1 thrust block.

5. The enhanced logdog in accordance with claim 1, wherein said means for <purpose> comprises a new attribute 1 relief hole.

6. An enhanced logdog for to provide a positive grip on a log or “cant” while giving clearance for the saw blade, comprising:
a new attribute 1 barrel, for <purpose>;
a new attribute 1 tooth bar, for <purpose>;
a new attribute 1 thrust block, for <purpose>; and
a new attribute 1 relief hole, for <purpose>.

7. An enhanced logdog for to provide a positive grip on a log or “cant” while giving clearance for the saw blade, comprising:
a new attribute 1 barrel, for <purpose>;
a new attribute 1 tooth bar, for <purpose>;
